(19) United States
(12) Patent Application Publication
(10) Pub. No.: US 2026/0124871 A1
(43) Pub. Date: May 7, 2026

(54) SUSPENSION SYSTEM INCLUDING A SUSPENSION DAMPER HAVING A MECHANICALLY ADJUSTABLE MOTION RATIO

(71) Applicant: GM GLOBAL TECHNOLGY OPERATIONS LLC, Detroit, MI (US)

(72) Inventor: Steven BAUMBACH, Farmington, MI (US)

(21) Appl. No.: 18/934,684

(22) Filed: Nov. 1, 2024

(51) Int. Cl. B60G 17/08; B60G 15/06; B60G 17/016

(52) U.S. Cl. CPC B60G 17/08; B60G 15/062; B60G 17/016; B60G 2200/142; B60G 2202/422; B60G 2500/10; B60G 2600/182

(57) ABSTRACT

A vehicle includes a body and a suspension member including a first end, a second end, and an intermediate portion extending between the first end and the second end. A guide element extends along the suspension member between the first end and the second end. A suspension damper module including a suspension damper is connected between the body and the suspension member, the suspension damper including a first damper member connected to the guide element and a second damper member connected to the body. An actuator member is operatively attached to the first damper member. The actuator member selectively shifts the first damper member along the guide element between the first end and the second end to adjust an effective damping characteristic of the suspension member.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle suspension systems and, more particularly, to a vehicle suspension system having a mechanically adjustable suspension damper.

Vehicles include suspension components that connect a vehicle body to vehicle wheels. The suspension system isolates the vehicle body from forces input through the wheels. The suspension components include springs and dampers that work in unison to maintain desirable vehicle trim height and isolate the vehicle body from forces input through the wheels. The amount of damping provided by the damper is tied to total vehicle body mass. Total vehicle body mass includes mass of components that form the vehicle body as well as an anticipated mass of passengers and loads supported by the vehicle body. Typically, the spring and damper characteristics are selected to provide a desired trim height at a specific total vehicle body mass and an appropriate amount of spring and damper control for a specific range of total vehicle body mass.

### SUMMARY

A vehicle, in accordance with the present disclosure, includes a body, a suspension member including a first end, a second end, and an intermediate portion extending between the first end and the second end. The second end of the suspension member is pivotally mounted to the body. A guide element extends along the suspension member between the first end and the second end. A suspension damper module including a suspension damper is connected between the body and the suspension member. The suspension damper including a first damper member connected to the guide element and a second damper member connected to the body. An actuator member is operatively attached to the first damper member. The actuator member selectively shifts the first damper member along the guide element between the first end and the second end to adjust an effective damping characteristic of the suspension member.

In other features, the first end of the suspension member is configured to translate relative to the body a first distance and the second damper member is configured to translate relative to the suspension member a second distance, the damping characteristic being a motion ratio of the first distance relative to the second distance.

In other features, the guide element includes a slot that extends along the intermediate portion of the suspension member between the first end and the second end.

In other features, the suspension member is a suspension arm.

In other features, a coil spring is disposed about the suspension damper forming a suspension module.

In other features, the actuator member comprises a linear actuator.

In other features, a suspension controller, the suspension controller is configured to detect a suspension condition of the body and adjust a position of the first damper member on the guide element to establish a selected damping characteristic of the suspension member.

A vehicle, in accordance with the present disclosure, includes a body and a suspension member including a first end, a second end, and an intermediate portion extending between the first end and the second end. The second end of the suspension member being pivotally mounted to the body. A suspension damper module including a suspension damper is connected between the body and the suspension member. The suspension damper includes a first damper member connected to the suspension member and a second damper member connected to the body. A dampening characteristic control mechanism is configured to adjust a dampening characteristic of the vehicle without adjusting damping characteristics of the suspension damper.

In other features, the suspension member includes a guide element extending between the first end and the second end, the first damper member being operatively connected to the guide element.

In other features, an actuator member is operatively attached to the first damper member, the actuator member selectively shifting the first damper member along the guide element between the first end and the second end to adjust the dampening characteristic of the suspension member.

In other features, the first end of the suspension member is configured to translate relative to the body a first distance and the second damper member is configured to translate relative to the suspension member a second distance, the dampening characteristic being a motion ratio of the first distance relative to the second distance.

In other features, the guide element includes a slot that extends along the intermediate portion of the suspension member between the first end and the second end.

In other features, a coil spring is disposed about the suspension damper forming a suspension module.

In other features, the dampening characteristic control mechanism comprises a linear actuator.

In other features, a suspension controller operatively connected to the linear actuator, the suspension controller being configured to detect a suspension characteristic of the body and adjust signal the dampening characteristic control mechanism to adjust the dampening characteristic of the vehicle.

A method of changing a dampening characteristic of a vehicle body without changing dampening characteristics of a suspension component, in accordance with the present disclosure, includes shifting a connection point of a suspension damper module on a suspension member to a selected position between a first end and a second end of the suspension component, the first end being configured to connect with a wheel and the second end being pivotally connected to the vehicle body.

In other features, shifting the connection point of the suspension damper module includes translating a terminal end of a hydraulic chamber along the suspension member.

In other features, translating the terminal end of the hydraulic chamber includes activating a motor connected to a linear actuator.

In other features, activating the motor includes counting rotations of the motor to establish the selected position.

In other features, the method includes sensing a suspension condition of the vehicle body and adjusting a position of the suspension damper module on the suspension member to establish a selected damping characteristic.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side partially cut-away view of a vehicle including a suspension system having a suspension spring/damper module with a mechanically adjustable motion ratio, in accordance with a non-limiting example;

FIG. 2 is a schematic view of the suspension system of FIG. 1 showing the suspension spring/damper module in a first adjusted position, in accordance with a non-limiting example; and

FIG. 3 is a block diagram depicting a suspension system controller for the suspension system of FIG. 2, in accordance with the present disclosure;

FIG. 4 is a flow chart illustrating a method of automatically adjusting a suspension characteristic of the vehicle, in accordance with a non-limiting example; and

FIG. 5 is a schematic view of the suspension system of FIG. 2 depicting the suspension spring/damper module in a second adjusted position, in accordance with the present disclosure.

In the drawings, reference numbers may be reused to identify similar and/or identical elements.

### DETAILED DESCRIPTION

Many vehicle suspension systems include tunable springs and/or dampers that may be adjusted to accommodate a wider range of vehicle body mass. Springs and/or dampers may be adjusted automatically through an on-board vehicle control system or manually by an operator. Automatic systems include hydraulic dampers having a magneto-rheological fluid that may change viscosity characteristics when exposed to an electric current. Other automatic systems may include flow path adjustments for the hydraulic fluid. Automatic spring/height control systems may include automatic adjustment mechanisms including valves that allow adjustment of fluid pressure (e.g., air). The Automatic spring/height control systems increase and/or decrease pressure in a sealed flexible element to adjust spring length as well as spring rate. Each system requires a complex array of sensors to detect changes in ride characteristics that may be adjusted by changing characteristics of the spring and/or the damper.

Manual spring and/or damper systems may include an adjustment mechanism such a valve allowing adjustment of pressure of a fluid (e.g., air) to vary dampener length. Increasing or decreasing dampener length adjusts the ride characteristics of the vehicle. The adjustment mechanism requires a source of pressurized fluid that may not always be available when needed. For example, some vehicle such as towing vehicles or commercial vehicles typically have changing load characteristics requiring frequent adjustment of the pressure of the fluid. Other manual damper adjustment systems may utilize an external control to adjust fluid flow paths and apply a preload to internal damping elements.

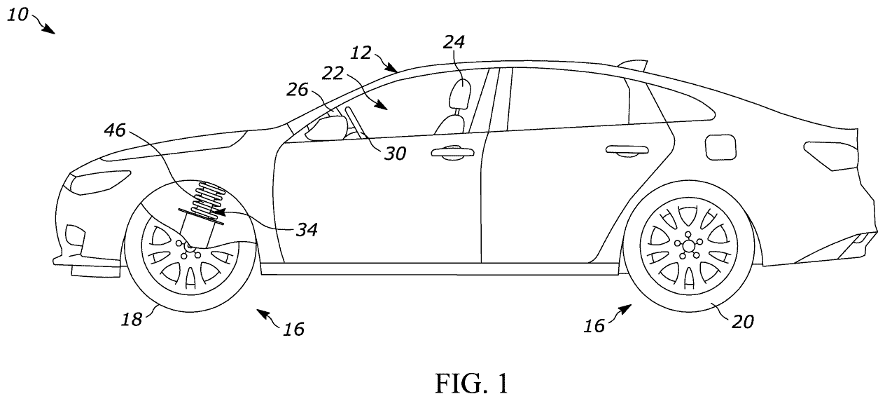

A vehicle, in accordance with the present disclosure, is indicated generally at 10 in FIG. 1. Vehicle 10 includes a body 12 supported on a plurality of wheels 16. Plurality of wheels 16 includes front wheels 18 and rear wheels 20. Body 12 defines, in part, a passenger compartment 22 within which is arranged a plurality of seats, one of which is indicated at 24. Seat 24 is positioned behind a dashboard 26. A steering wheel 30 is arranged between dashboard 26 and seat 24. Body 12 is connected to each of the plurality of wheels 16 through a suspension system 34 such as shown in connection with front wheel 18. Suspension system 34 is designed to support body 12 and accommodate various road conditions to provide a comfortable ride.

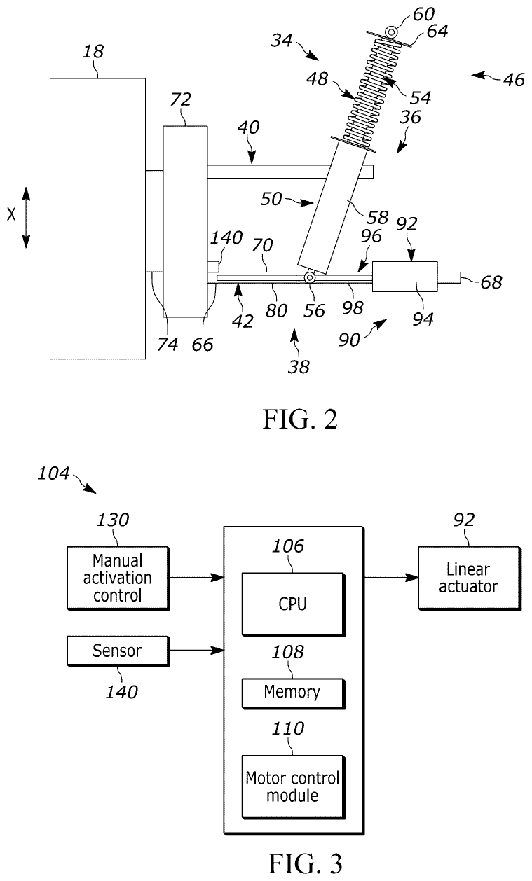

Referring to FIG. 2, suspension system 34 includes a first suspension member 36 and a second suspension member 38 that connect one of the front wheels 18 to body 12. The other of the front wheels 18 is connected in a similar manner. Likewise, rear wheels 20 are connected to body 12 through suspension members (not shown). First suspension member 36 constitutes an upper suspension arm 40 and second suspension member 38 constitutes a lower suspension arm 42.

Suspension system 34 also includes a suspension spring and damper module 46, shown in the form of a steel coil spring 48 mounted on a hydraulic shock absorber 50 that is connected between body 12 and lower suspension arm 42. Spring and damper module 46 may, in the alternative, connect body 12 with upper suspension arm 40 depending on vehicle design. At this point, it should be understood that while shown as including a suspension spring and damper module, the coil spring may be removed from the system forming a suspension damper module including only the hydraulic shock absorber (or other energy absorbing device).

The hydraulic shock absorber includes a first damper member shown in the form of a hydraulic chamber 52 that houses a hydraulic fluid system (not shown) and a second damper member shown in the form of a piston rod 54 that is shiftable into and out from hydraulic chamber 52. The hydraulic fluid system in hydraulic chamber 52 dampens movement of piston rod 54.

Hydraulic chamber 52 includes a first end portion 56 connected to lower suspension arm 42 a second end portion 58. Piston rod 54 includes a first end section (not shown) that resides within hydraulic chamber 52 and a terminal end 60 that connects to body 12 through a vehicle frame (not shown). Steel coil spring 48 extends about piston rod 54 and is supported between a first spring seat 62 and a second spring seat 64. First spring seat 62 resides at second end portion 58 of hydraulic chamber 52 and second spring seat 64 resides adjacent to terminal end 60 of piston rod 54. At this point, it should be understood that while described in terms of a hydraulic shock absorber, suspension spring and damper module 46 may take on various forms including other energy absorbing devices such as pneumatic dampers, spring dampers, and the like.

In accordance with the present disclosure, lower suspension arm 42 includes a first end 66 that is operatively connected with front wheel 18, a second end 68, and an intermediate portion 70 that extends between first end 66 and second end 68. First end 66 may be connected to front wheel 18 through, for example, a steering knuckle 72. Steering knuckle 72 is connected to a hub 74 that is connected to front wheel 18 through a plurality of fasteners (not shown). A guide element 80, which may take the form of a guide track (not separately labeled), extends along lower suspension arm 42 between first end 66 and second end 68. First end portion 56 of hydraulic shock absorber 50 is connected to guide element 80 and is configured to translate along lower suspension arm 42 between first end 66 and second end 68 as will be detailed herein.

In further accordance with the present disclosure, suspension system 34 includes an actuator member 90 connected to first end portion 56 of hydraulic shock absorber 50. Actuator member 90 is shown in the form of a linear actuator 92 including a motor 94 and an actuator portion 96. Actuator portion 96 may take on various forms. In accordance with one exemplary aspect, actuator portion 96 may take the form of an extendable rod 98 as shown. In accordance with another exemplary aspect, actuator portion 96 may take the form of a worm screw. In either example, motor 94 is selectively activated to cause actuator portion 96 to shift first end portion 56 of hydraulic shock absorber 50 along intermediate portion 70 between first end 66 and second end 68.

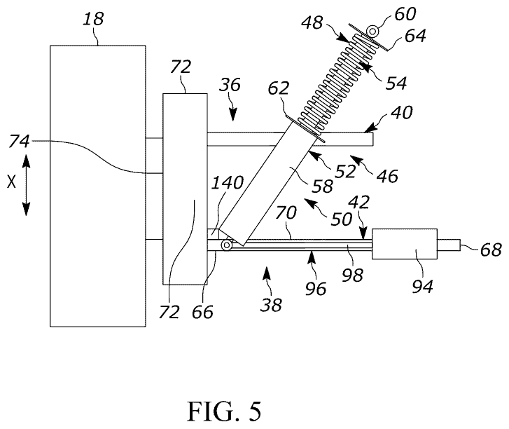

Shifting first end portion 56 of hydraulic chamber 52 relative to first end 66 changes a motion ratio of lower suspension arm 42 and piston rod 54. That is, the closer terminal end 60 is attached to second end 68 of lower suspension arm 42 the shorter the distance piston rod 54 will extend from hydraulic chamber 52. As the connection point between first end portion 56 moves toward steering knuckle 72, the longer piston rod 54 will extend from hydraulic chamber 52. In other words, when first end portion 56 of piston rod 54 is connected closer to second end 68 as shown in FIG. 2, front wheel 18 may translate vertically a distance “X”. As first end portion 56 moves toward first end 66 as shown in FIG. 5, that vertical translation increases.

In accordance with the present disclosure, linear actuator 92 is connected to a suspension controller 104 as shown in FIG. 3. Suspension controller 104 includes a central processing unit (CPU) 106, a non-transient memory module 108, and a motor control module 110. Motor control module 110 interacts with linear actuator 92 to establish a selected position for first end portion 56 of piston rod 54. For example, motor control module 110 may count rotations of motor 94 when moving actuator portion 96 relative to guide element 80. Non-transient memory module 108 may store one or more user selectable positions for first end portion 56 that are input through a manual activation control 130 or may include instructions for moving first end portion 56 along guide element 80 based on suspension characteristics perceived by a suspension sensor 140.

Suspension sensor 140 may take the form of a height sensor arranged along lower suspension arm 42 and connected to body 12. Suspension sensor 140 provides feedback to suspension controller 104 that may be used by motor control module 110 to shift first end portion 56 of hydraulic chamber 52 along guide element 80 to adjust the suspension characteristic of vehicle 10. The ride characteristics may be adjusted to accommodate changes in vehicle payload, vehicle trim height, or other factors that require spring and dampening characteristics to be adjusted to create a smooth ride experience.

At this point, it should be understood that the term “suspension characteristics” describes one or more parameters including trim height, spring rate, dampening characteristics, and the like that would affect vertical movement of, for example, lower suspension arm 42. At this point, it should be understood that while shown and described as being co-located, the various components that form suspension controller 104 may be embodied in a different components of vehicle 10.

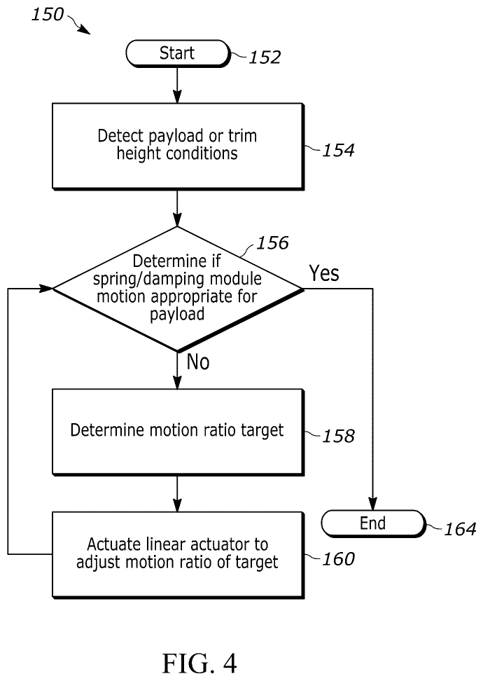

Reference will now follow to FIG. 4 in describing a method 150 of adjusting the suspension characteristics of vehicle 10 in accordance with the present disclosure. Upon receiving a signal that vehicle 10 is ready to travel, such as through a key fob or the like, method 150 starts in block 152. In block 154 suspension sensor 140 detects one or more suspension characteristics of vehicle 10. For example, suspension sensor 140 may detect a change in trim height through a change in compression of one or more shock absorbers resulting in movement of lower suspension arm 42. Suspension sensor 140 may also detect a change in payload by sensing a change in a weight on wheels parameter through additional sensors (not shown).

At this point, suspension controller 104 determines whether the detected suspension characteristic detected in block 154 falls within a selected limit associated with the current position of first end portion 56 of hydraulic chamber 52 in block 156. If not, suspension controller 104, through motor control module 110, will activate linear actuator 92 to move first end portion 56 to a selected position that results in the detected suspension characteristic being within the selected limits in block 160. The selected position may be achieved by counting rotations of motor 94 in motor control module 110. Suspension controller 104 then rechecks that the detected suspension characteristics are within the selected limits in block 156. When the detected suspension characteristic is determined to be within the selected limit, method 150 ends in block 164. While described as occurring at start up, method 150 may engage at any time vehicle 10 is powered on to ensure that the passengers experience desirable ride and handling characteristics as well as reducing loads on body 12.

At this point, it should be understood, that the present disclosure describes a system for adjusting a motion ratio of a vehicle suspension component without requiring changes in the suspension spring and damper module 46. That is, the damping characteristic of the suspension damper remains unchanged. The system relies on a change in the moment arm of the suspension component carried out by a simple linear movement of the terminal end of the suspension dampener. The change in moment arm can result in a change in the motion ratio of the suspension system. It has been shown that by changing the motion ratio of suspension spring and damper module 46 from, for example, 0.5 to 0.75, can increase wheel damping and wheel rate up to 125%.

In an example vehicle with 0.50 motion ratio, with nominal axle load of 1500 kg, nominal ride frequency of 1.2 HZ, 200 kg unspring axle mass, 375 N/mm wheel rate, and 7.5 N/mm bushing contribution to wheel rate, adding an axle payload of 1000 kg, the trim height lowers by 146 mm, ride frequency is reduced to 0.90 Hz, with no change in effective wheel damping. In the same example with the motion ratio changed from 0.5 to 0.75, the vehicle with the same payload would experience a small trim height change of 37 mm, would have a ride frequency of 1.22 Hz, similar to the unloaded vehicle, and would have 125% higher damper forces for same wheel velocities.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A vehicle comprising:
a body;
a suspension member including a first end, a second end, and an intermediate portion extending between the first end and the second end, the second end of the suspension member being pivotally mounted to the body;
a guide element extending along the suspension member between the first end and the second end;
a suspension damper module including a suspension damper connected between the body and the suspension member, the suspension damper including a first damper member connected to the guide element and a second damper member connected to the body;
an actuator member operatively attached to the first damper member, the actuator member selectively shifting the first damper member along the guide element between the first end and the second end to adjust an effective damping characteristic of the suspension member;
a suspension sensor configured to detect a ride characteristic of the vehicle; and
a suspension controller operatively connected to the actuator member and the suspension sensor, the suspension controller including a non-transient memory module having stored therein a plurality of positions for the actuator member; and
a manual activation control operatively connected to the suspension controller, wherein the suspension controller is configured to activate the actuator member to adjust a position of the first damper member on the guide element to one of the plurality of positions input into the non-transient memory module, through the manual activation control, to establish a selected damping characteristic of the suspension member.

2. The vehicle according to claim 1, wherein the first end of the suspension member is configured to translate relative to the body a first distance and the second damper member is configured to translate relative to the suspension member a second distance, the damping characteristic being a motion ratio of the first distance relative to the second distance.

3. The vehicle according to claim 1, wherein the guide element includes a slot that extends along the intermediate portion of the suspension member between the first end and the second end.

4. The vehicle according to claim 1, wherein the suspension member is a suspension arm.

5. The vehicle according to claim 1, further comprising a coil spring disposed about the suspension damper, the suspension damper module being a suspension spring and damper module.

6. The vehicle according to claim 1, wherein the actuator member comprises a linear actuator.

7. (canceled)

8. A vehicle comprising:
a body;
a suspension member including a first end, a second end, and an intermediate portion extending between the first end and the second end, the second end being pivotally mounted to the body;
a guide element extending along the suspension member between the first end and the second end;
a suspension damper module including a suspension damper connected between the body and the suspension member, the suspension damper including a first damper member connected to the suspension member and a second damper member connected to the body;
a dampening characteristic control mechanism configured to adjust a dampening characteristic of the vehicle without adjusting damping characteristics of the suspension damper;
a suspension sensor configured to detect a ride characteristic of the vehicle; and
a suspension controller operatively connected to the dampening characteristic control mechanism and the suspension sensor, the suspension controller including a non-transient memory module having stored therein a plurality of positions for the first damper member; and
a manual activation control operatively connected to the suspension controller, wherein the suspension controller is configured to activate the dampening characteristic control mechanism to adjust a position of the first damper member on the guide element to one of the plurality of positions input into the non-transient memory module, through the manual activation control, to establish a selected damping characteristic of the suspension member.

9. The vehicle according to claim 8, wherein the first damper member being is operatively connected to the guide element.

10. The vehicle according to claim 9, further comprising an actuator member operatively attached to the first damper member, the actuator member selectively shifting the first damper member along the guide element between the first end and the second end to adjust the dampening characteristic of the suspension member.

11. The vehicle according to claim 10, wherein the first end of the suspension member is configured to translate relative to the body a first distance and the second damper member is configured to translate relative to the suspension member a second distance, the dampening characteristic being a motion ratio of the first distance relative to the second distance.

12. The vehicle according to claim 11, wherein the guide element includes a slot that extends along the intermediate portion of the suspension member between the first end and the second end.

13. The vehicle according to claim 9, further comprising a coil spring disposed about the suspension damper, the suspension damper module being a suspension spring and damper module.

14-20. (canceled)
